(19) United States
(12) Patent Application Publication
(10) Pub. No.: US 2012/0138228 A1
(43) Pub. Date: Jun. 7, 2012

(54) DEEP-TRENCH SILICON ETCHING AND GAS INLET SYSTEM THEREOF

(75) Inventor: Yang Zhou, Beijing (CN)

(73) Assignee: Beijing NMC Co., Ltd., Beijing (CN)

(21) Appl. No.: 13/321,794

(22) PCT Filed: Aug. 19, 2010
(86) PCT No.: PCT/CN2010/076152

§ 371 Date: Nov. 21, 2011

(30) Foreign Application Priority Data
Aug. 27, 2009 (CN) 200910091856.3

(51) Int. Cl. B05B 1/02; F03B 11/02

(52) U.S. Cl. 156/345.29; 137/561 R

(57) ABSTRACT

A deep-trench silicon etching apparatus, including a reaction chamber and a gas source cabinet, the gas source cabinet is connected to the reaction chamber via two independently controlled gas paths; wherein, a first gas path is used to introduce process gas for etch step from the gas source cabinet into the reaction chamber; a second gas path is used to introduce process gas for deposition step from the gas source cabinet into the reaction chamber. The present invention is used to solve the problems of gas mixture and gas delay occurring when process steps are switched.

### FIELD OF THE INVENTION

The invention relates to the field of semiconductor manufacturing, especially to a deep-trench silicon etching apparatus and a gas inlet system thereof used for semiconductor wafer processing.

### BACKGROUND OF THE INVENTION

As MEMS (Micro-Electro-Mechanical System) has been widely used in the fields of motor vehicles and consumer electronics, and as TSV (Through Silicon Vias) technique has a broad application in the field of future packaging, deep-trench silicon etching process with dry plasma has become a main processing technique for MEMS.

Currently, a typical deep-trench silicon etching process is a Bosch process which is characterized in that a complete etch process alternatively cycles between etch and deposition steps. The process gas used in the etch step is SF₆ (sulphur hexafluoride). Although this process gas can etch the silicon substrate with a very high etch rate, since this kind of etch is isotropic, so it is difficult to control sidewall morphology. In order to reduce etching the sidewall, a deposition step is added into this process. That is, a layer of polymer protecting film is deposited on the sidewall to protect the sidewall from being etched, so as to etch only in the vertical plane. Referring to FIG. 1, a typical etch process of the Bosch process is illustrated as an example. FIG. 1a shows morphology of an unetched silicon chip, which includes a photoresist layer 101 and an etched silicon body 102; FIGS. 1b, 1d and 1f show morphology of the silicon chip in the etch steps which are isotropic etching with SF₆; FIGS. 1c and 1e show morphology of the silicon chip in the deposition steps during which C₄F₈ (perfluoro-2-butene) is used to form a deposition layer for protecting the sidewall; in FIG. 1, the etch steps and the deposition steps are alternatively made, and FIG. 1g is a final morphology of the silicon chip after several cycles between etch and deposition steps.

Referring to FIG. 2, a typical silicon etching apparatus is shown. When the Bosch etch process mentioned above is performed, a silicon chip 202 is introduced into the process chamber 201 and placed on the electrostatic chuck (ESC) 203. After the electrostatic chuck 203 finishes adsorbing the silicon chip 202, process gas is controlled to enter the process chamber 201 from the gas source cabinet 207 via the gas path 206 and the nozzle 204, and is applied with RF (Radio Frequency) power to generate plasma 205, so as to achieve etching of the silicon chip 202.

Since all process gas enter the process chamber 201 via the same gas path 206 and the same nozzle 204 in the apparatus of FIG. 2, when the etch step is finished, a portion of etching gas will retain in the gas path 206, When the subsequent deposition step starts, deposition gas needs to push the etching gas retained in the gas path 206 into the process chamber 210, and then the deposition gas can enter into the process chamber 201. Thus, when the deposition step starts, gas which first enters into the process chamber 201 is the etching gas rather than the deposition gas. Similarly, when the etch step starts, gas which first enters into the process chamber 201 is the deposition gas rather than the etching gas. Thereby, there is a problem of gas mixture when the etch step and the deposition step are switched and it has an adverse effect on accurate control of the process.

Moreover, all process gas enters into the process chamber 201 via the same gas inlet pipeline and the same nozzle, so that the etching gas has a certain delay in the etch step and the deposition gas has a certain delay in the deposition step. Since frequent switching between the etch step and the deposition step needs to be performed in the deep-trench silicon etching process, and the time interval between two continuous switching is very short, such a gas delay due to switching between the two steps will greatly affect process accuracy and process efficiency.

In summary, a problem to be solved by the persons skilled in the art imminently is how to improve the prior art gas inlet system so as to solve the problems of gas mixture and gas delay occurring when process steps are switched,

### SUMMARY

A technical problem to be solved by the present invention is to provide a deep-trench silicon etching apparatus and a gas inlet system thereof, to solve the problems of gas mixture and gas delay occurring when process steps are switched, in turn to achieve accurate control of process gas flow in the deep-trench silicon etching process, so as to further increase accuracy and efficiency of the deep-trench silicon etching process.

In order to solve the problems mentioned above, the present invention discloses a deep-trench silicon etching apparatus, including: a reaction chamber and a gas source cabinet, the gas source cabinet is connected to the reaction chamber via two independently controlled gas paths; wherein a first gas path is used to introduce process gas for etch step from the gas source cabinet into the reaction chamber; a second gas path is used to introduce process gas for deposition step from the gas source cabinet into the reaction chamber.

Preferably, the two independently controlled gas paths include two gas inlet pipelines and one gas inlet nozzle; the two gas inlet pipelines are connected with process gas for etch step and process gas for deposition step respectively, and both are connected to the reaction chamber via the gas inlet nozzle.

Preferably, the gas inlet nozzle includes an inner layer nozzle and an outer layer nozzle; the inner layer nozzle and the outer layer nozzle are connected to the two gas inlet pipelines respectively.

Preferably, the inner layer nozzle is a central through hole within the gas inlet nozzle, one end of the central through hole is connected to the first gas inlet pipeline and the other end thereof is connected into the reaction chamber; the outer layer nozzle includes a gas inlet hole connected to the second gas inlet pipeline, a homogenizing chamber connected to the gas inlet hole, flow division holes connected to the homogenizing chamber, and a gas outlet channel connected to the flow division holes.

Preferably, an axis of the gas inlet hole of the outer layer nozzle is perpendicular to an axis of the through hole of the inner layer nozzle; the homogenizing chamber of the outer layer nozzle is a hollow ring surrounding the through hole of the inner layer nozzle; the gas outlet channel of the outer layer nozzle is another hollow ring surrounding the through hole of the inner layer nozzle and connected to the reaction chamber.

Preferably, the gas inlet nozzle includes an intermediate nozzle and a flow homogenizing board; one end of the intermediate nozzle is connected to the first gas inlet pipeline and the other end thereof is connected into the reaction chamber; the flow homogenizing board is provided with a gas inlet hole, a homogenizing chamber and gas outlet holes thereon, wherein the gas inlet hole is connected to the second gas inlet pipeline.

An embodiment of the present invention further discloses a gas inlet system of a deep-trench silicon etching apparatus, including: two independently controlled gas paths connected between a gas source cabinet and a reaction chamber; wherein, a first gas path is used to introduce process gas for etch step from the gas source cabinet into the reaction chamber; a second gas path is used to introduce process gas for deposition step from the gas source cabinet into the reaction chamber.

Preferably, the two independently controlled gas paths include two gas inlet pipelines and one gas inlet nozzle; the two gas inlet pipelines are connected to process gas for etch step and process gas for deposition step respectively, and both are connected to the reaction chamber via the gas inlet nozzle.

Preferably, the gas inlet nozzle includes an inner layer nozzle and an outer layer nozzle; the inner layer nozzle and the outer layer nozzle are connected to the two gas inlet pipelines respectively.

Preferably, the inner layer nozzle is a central through hole within the gas inlet nozzle, one end of the central through hole is connected to the first gas inlet pipeline and the other end thereof is connected into the reaction chamber; the outer layer nozzle includes a gas inlet hole connected to the second gas inlet pipeline, a homogenizing chamber connected to the gas inlet hole, flow division holes connected to the homogenizing chamber, and a gas outlet channel connected to the flow division holes.

Preferably, an axis of the gas inlet hole of the outer layer nozzle is perpendicular to an axis of the through hole of the inner layer nozzle; the homogenizing chamber of the outer layer nozzle is a hollow ring surrounding the through hole of the inner layer nozzle; the gas outlet channel of the outer layer nozzle is another hollow ring surrounding the through hole of the inner layer nozzle and connected to the reaction chamber.

Preferably, the gas inlet nozzle includes an intermediate nozzle and a flow homogenizing board; one end of the intermediate nozzle is connected to the first gas inlet pipeline and the other end thereof is connected into the reaction chamber; the flow homogenizing board is provided with a gas inlet hole, a homogenizing chamber and gas outlet holes thereon, wherein the gas inlet hole is connected to the second gas inlet pipeline.

Compared with the prior art, the present invention presents following advantages:

Since process gas for etch step and process gas for deposition step enter into the reaction chamber by means of two different gas paths, thus when the etch step is finished, process gas for etch step can retain in the first gas path, and when the subsequent deposition step starts, process gas for deposition step can enter into the reaction chamber by means of the second gas path; similarly, when the deposition step is switched to the etch step, process gas for deposition step retains in the second gas path and does not affect the first gas path in which process gas for etch step retains. Therefore, the present invention can eliminate the problem of process gas mixture when steps are switched, so as to achieve accurate control of process gas flow in a deep-trench silicon etching process.

Thus, since process gas for etch step and process gas for deposition step are independently controlled to inlet by the two gas paths, switching of the pipelines is not necessary in the gas source cabinet. Thus, in the case that the two steps are switched frequently and the time interval between two continuous switching is very short, the problem of process gas delay can be avoided, so as to increase accuracy and efficiency of the deep-trench silicon etching process.

### BRIEF DESCRIPTION OF THE DRAWINGS

FIG. 1 is an example illustrating a typical etching process of the prior art Bosch process;

FIG. 2 is a schematic view illustrating a structure of a typical silicon etching apparatus in the prior art;

FIG. 3 is a schematic view illustrating a structure of a deep-trench silicon etching apparatus according to a first embodiment of the present invention;

FIG. 4 is a schematic view illustrating a structure of a deep-trench silicon etching apparatus according to a second embodiment of the present invention;

FIG. 5 is a schematic view of a gas inlet nozzle used in the second embodiment shown in FIG. 4;

FIG. 6 is a schematic view illustrating a structure of a deep-trench silicon etching apparatus according to a third embodiment of the present invention; and

FIG. 7 is a schematic view illustrating a structure of a flow homogenizing board in the embodiment shown in FIG. 6.

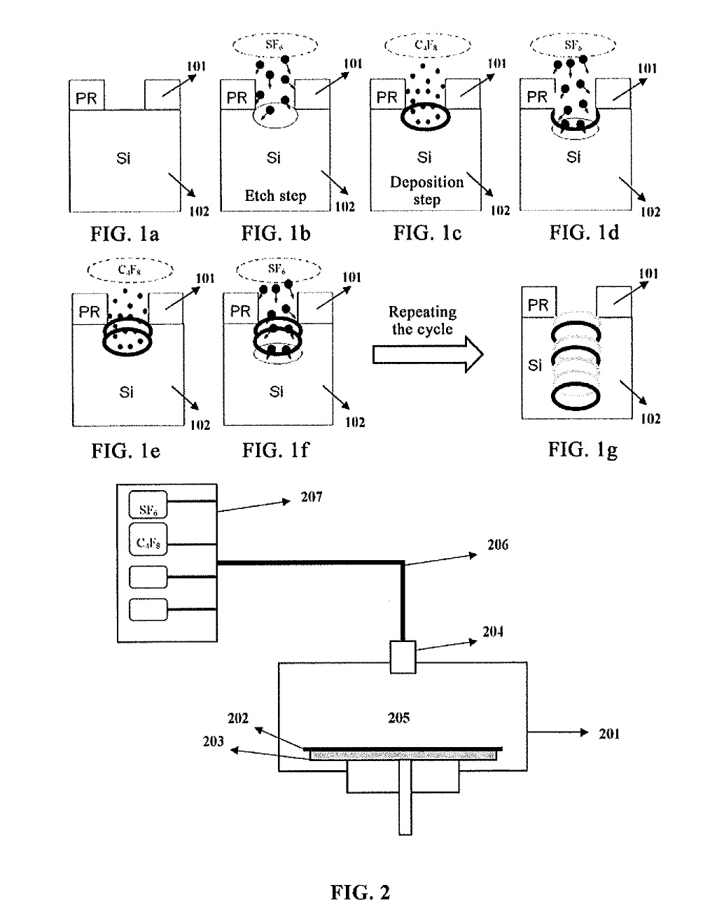

### DETAILED DESCRIPTION OF THE PREFERRED EMBODIMENT

In order to make above mentioned objects, features and advantages of the present invention more apparent and easier to be understood, the present invention will be further described in detail in connection with the accompanying figures and the particular embodiments below.

Referring to FIG. 3, a structure of a deep-trench silicon etching apparatus according to the first embodiment of the present invention is shown. The deep-trench silicon etching apparatus provided by the embodiment may particularly include a reaction chamber 301 and a gas source cabinet 302, the gas source cabinet 302 is connected to the reaction chamber 301 via two independently controlled gas paths, wherein a first gas path 303 is used to introduce process gas for etch step from the gas source cabinet 302 into the reaction chamber 301; a second gas path is used to introduce process gas for deposition step from the gas source cabinet 302 into the reaction chamber 301.

Since process gas for etch step and process gas for deposition step enter into the reaction chamber by means of two different gas paths, thus when the etch step is over, process gas for etch step can retain in the first gas path 303, which has no effect on process gas entering into the reaction chamber for subsequent deposition step. Likewise, when the deposition step is switched to the etch step, process gas for deposition step retains in the second gas path 304 and also does not affect the subsequent etch step. Therefore, the present invention can eliminate the problem of process gas mixture when steps are switched.

Particularly, the first gas path 303 can include a first gas inlet pipeline 330 connected to the gas source cabinet 302 and a first gas inlet nozzle 331 fixed on the reaction chamber 301, process gas for etch step is introduced from the gas source cabinet 302 into the reaction chamber 301 via the first gas inlet pipeline 330 and the first gas inlet nozzle 331; the second gas path 304 can include a second gas inlet pipeline 340 connected to the gas source cabinet 302 and a second gas inlet nozzle 341 fixed on the reaction chamber 301, process gas for deposition step is introduced from the gas source cabinet 302 into the reaction chamber 301 via the second gas inlet pipeline 340 and the second gas inlet nozzle 341.

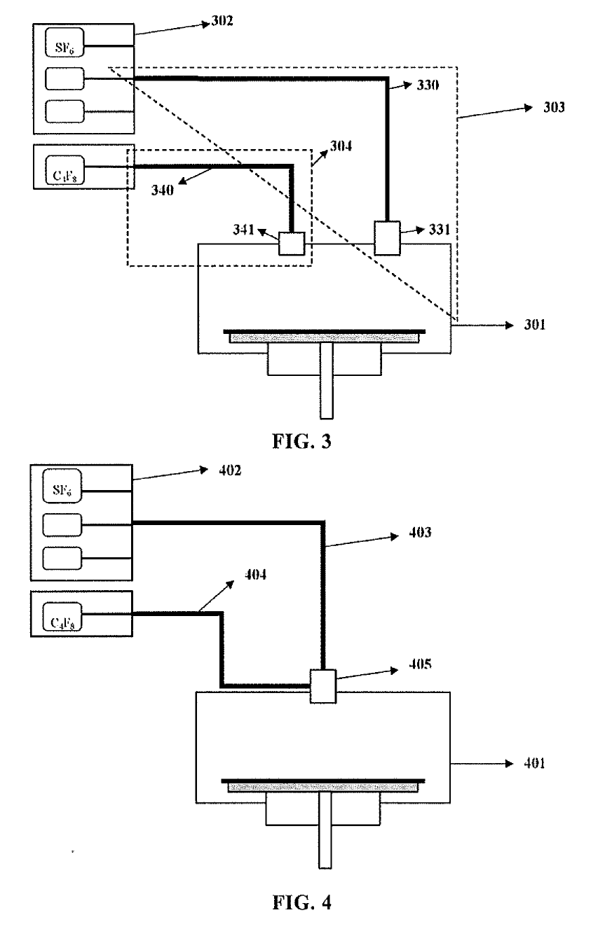

In practice, the first gas path and the second gas path can use one common gas inlet nozzle. Referring to FIG. 4, a schematic view illustrating a structure of a deep-trench silicon etching apparatus according to a second embodiment of the present invention in such application is shown. The deep-trench silicon etching apparatus provided by the embodiment may particularly include a reaction chamber 401, a gas source cabinet 402, a first gas inlet pipeline 403 and a second gas inlet pipeline 404 connected to the gas source cabinet 402, and a gas inlet nozzle 405 respectively connected to the first gas inlet pipeline 403 and the second gas inlet pipeline 404. Although one gas inlet nozzle is employed to introduce different process gases into the reaction chamber in the present embodiment, since two independent pipelines are used to introduce different process gases, the effect of the present invention is not affected.

Different etch processes require different process gases, for example, some kind of etch process uses SF₆ and O₂ as process gas for etch step, and another kind of etch process uses SF₆ and He (Helium) as process gas for etch step. In this case, process gas for etch step needs to be selected, for example, process gas of SF₆ and O₂ or process gas of SF₆ and He, which should enter into the first gas path based on the process requirements, that is, process gas entering into the first gas path includes primary etching gas and auxiliary gas.

It should be understood that persons skilled in the art can make other modifications on the structure of the first gas path according to practical requirements, or modify the structure of the second gas path according to requirements of process gas for deposition step. Means mentioned above are only illustrated as examples, and structures of the first gas path and the second gas path in the present invention are not limited.

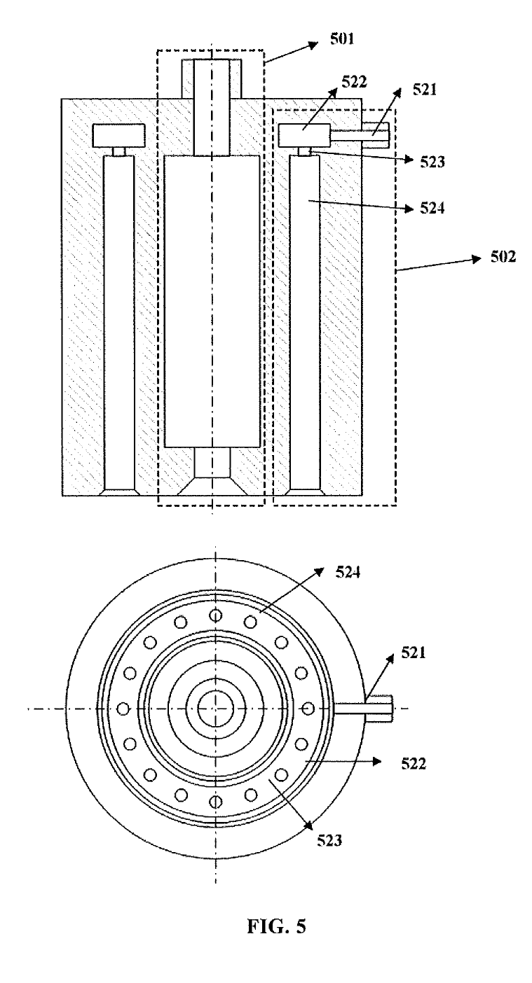

Referring to FIG. 5, a schematic view of a structure of a gas inlet nozzle used in the second embodiment is shown, the gas inlet nozzle has a structure of a cylinder (can also be other structures such as a square cylinder), and consists of an inner layer nozzle 501 and an outer layer nozzle 502. Wherein, the inner layer nozzle 501 is a central through hole within the cylinder, one end of the central through hole is connected to the first gas inlet pipeline and the other end thereof is connected into the reaction chamber; the central through hole has a structure of stepped hole with a small hole diameter at both ends and a large hole diameter in the middle, and a chamfer angle is provided at one end of the small hole connecting the gas inlet nozzle with the reaction chamber. The above design of the chamfer angle and varying hole diameters can increase incident angle of gas and improve uniformity of gas distribution.

The outer layer nozzle 502 includes a gas inlet hole 521 connected to the second gas inlet pipeline, a homogenizing chamber 522 connected to the gas inlet hole 521, flow division holes 523 connected to the homogenizing chamber 522, and a gas outlet channel 524 connected to the flow division holes 523.

Wherein, in a preferred embodiment of the present invention, the gas inlet hole 521 is fixed on a wall of the cylinder of the gas inlet nozzle, an axis of the gas inlet hole 521 is perpendicular to an axis of the central through hole 501 of the inner layer nozzle; the homogenizing chamber 522 is a hollow ring surrounding the central through hole 501 of the inner layer nozzle; flow division holes 523 are uniformly distributed around the central through hole 501 of the inner layer nozzle; the gas outlet channel 524 is another hollow ring surrounding the central through hole 501 of the inner layer nozzle and connected to the reaction chamber. Process gas for deposition step enters into the homogenizing chamber 522 via the gas inlet hole 521, and then enters into the reaction chamber via the flow division holes 523 and the gas outlet channel 524. Since process gas entering into the reaction chamber for deposition step is uniformly distributed by the homogenizing chamber 522 and the flow division holes 523, the present embodiment can achieve an uniform control of the flow of process gas for deposition step.

It should be understood that the structure of the gas inlet nozzle shown in FIG. 5 is only illustrated as an example. The persons skilled in the art can employ any structure of the gas inlet nozzle according to practical requirements, for example, the central through hole of the inner layer nozzle is just a simple through hole, or the central through hole is a stepped hole with a large hole diameter at both ends and a small hole diameter in the middle.

In an alternative embodiment, the outer layer nozzle includes a gas inlet hole connected to the second gas inlet pipeline, a homogenizing chamber connected to the gas inlet hole, and flow division holes connected to the homogenizing chamber, wherein the flow division holes are connected to the reaction chamber directly, and so on. Summarily, the present invention has no limit on the structure and the position of the gas inlet hole of the outer layer nozzle, and has no limit on the structure of the homogenizing chamber etc. Of course, for a simplest outer layer nozzle, it is feasible even if the outer layer nozzle does not include the homogenizing chamber and the flow division holes.

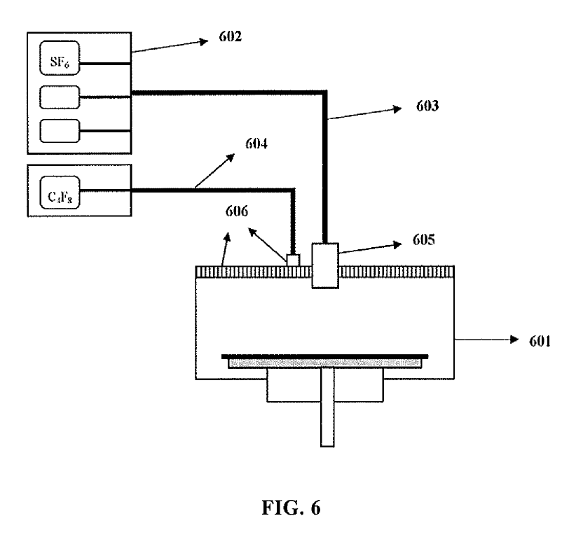

Referring to FIG. 6, a structure of a deep-trench silicon etching apparatus according to a third embodiment of the present invention is shown. The difference between the present embodiment and the second embodiment is the structure of the gas inlet nozzle. The gas inlet nozzle in the present embodiment includes an intermediate nozzle 605 and a flow homogenizing board 606 (that is, the outer layer nozzle in the second embodiment is replaced by the flow homogenizing board). Wherein, one end of the intermediate nozzle 605 is connected to a first gas inlet pipeline 603 and the other end thereof is connected into a reaction chamber 601; the flow homogenizing board 606 is used to introduce process gas for deposition step from a gas source cabinet 602 into the reaction chamber 601 via a second gas inlet pipeline 604.

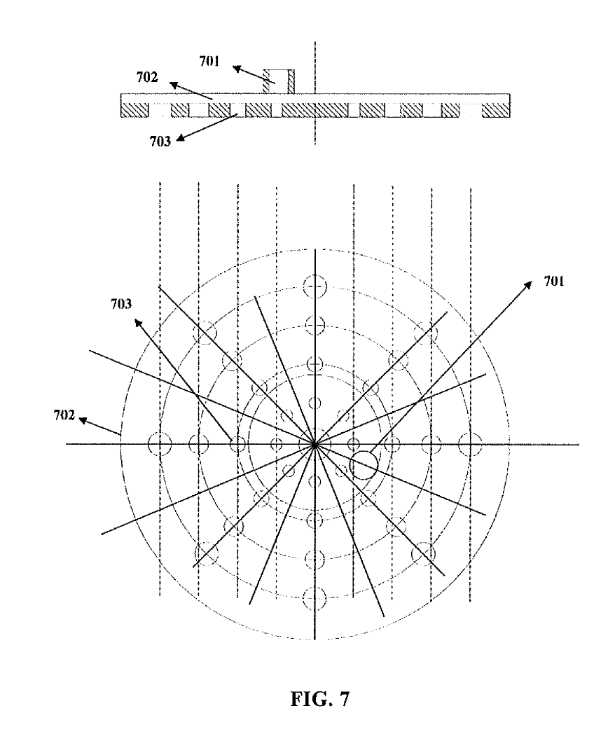

Referring to FIG. 7, a schematic view of a structure of a flow homogenizing board in the embodiment shown in FIG. 6 is illustrated. The flow homogenizing board is provided with a gas inlet hole 701, a homogenizing chamber 702 and gas outlet holes 703 thereon. Wherein, the gas inlet hole 701 is connected to the second gas inlet pipeline, and the size, the shape and the distribution etc. of the gas outlet holes 703 are not limited. Process gas for deposition step enters into the homogenizing chamber 702 via the gas inlet hole 701, and then enters into the reaction chamber via the gas outlet holes 703. Since the homogenizing chamber 702 has uniformly distributed the process gas entering into the reaction chamber for deposition step, an accurate control of the flow of process gas for deposition step can be achieved. Preferably, the gas inlet hole 701 and the gas outlet holes 703 are designed to be non-coaxial, so as to prevent gas flowing out directly.

Of course, the structure of the gas inlet nozzle mentioned above is only shown as an example. The persons skilled in the art can employ other structures of the gas inlet nozzle according to requirements. For example, the gas inlet nozzle can include two flow homogenizing boards, or the flow homogenizing board can be modified in other manners. Summarily, the present invention has no limit on the structure of the gas inlet nozzle.

In the above, the deep-trench silicon etching apparatus of the present invention, including a gas source cabinet, a reaction chamber and a gas inlet system, have been described in detail. It can be seen that the present invention can provide a gas inlet system for a deep-trench silicon etching apparatus. In one embodiment of the gas inlet system provided by the present invention, the gas inlet system can particularly include: two independently controlled gas paths connected between a gas source cabinet and a reaction chamber respectively; wherein, a first gas path is used to introduce process gas for etch step from the gas source cabinet into the reaction chamber; a second gas path is used to introduce process gas for deposition step from the gas source cabinet into the reaction chamber.

In a preferred embodiment of the gas inlet system, the two independently controlled gas paths can include two gas inlet pipelines and one gas inlet nozzle; wherein, the two gas inlet pipelines are connected to process gas for etch step and process gas for deposition step respectively, and both are connected to the reaction chamber via the gas inlet nozzle.

In a preferred embodiment of the gas inlet system, the gas inlet nozzle can include an inner layer nozzle and an outer layer nozzle, wherein, the inner layer nozzle and the outer layer nozzle are connected to the two gas inlet pipelines respectively.

In a particular embodiment, the inner layer nozzle can be a central through hole within the gas inlet nozzle, one end of the central through hole is connected to the first gas inlet pipeline and the other end thereof is connected into the reaction chamber; the outer layer nozzle can include a gas inlet hole connected to the second gas inlet pipeline, a homogenizing chamber connected to the gas inlet hole, flow division holes connected to the homogenizing chamber, and a gas outlet channel connected to the flow division holes.

Preferably, an axis of the gas inlet hole of the outer layer nozzle is perpendicular to an axis of the through hole of the inner layer nozzle; the homogenizing chamber of the outer layer nozzle can be a hollow ring surrounding the through hole of the inner layer nozzle; the gas outlet channel of the outer layer nozzle can be another hollow ring surrounding the through hole of the inner layer nozzle and connected to the reaction chamber.

In order to assure that an uniform control of process gas for deposition step is also achieved, in practical applications, the gas inlet nozzle can be achieved with a structure including an intermediate nozzle and a flow homogenizing board; wherein, one end of the intermediate nozzle is connected to the first gas inlet pipeline and the other end thereof is connected into the reaction chamber; the flow homogenizing board is provided with a gas inlet hole, a homogenizing chamber and gas outlet holes thereon, wherein, the gas inlet hole is connected to the second gas inlet pipeline.

It can be understood that the persons skilled in the art can employ other structures of the first gas path, the second path or the gas inlet nozzle according to practical requirements, and the present invention has no limit on the particular structures of the first gas path, the second gas path and the gas inlet nozzle.

In the above, the deep-trench silicon etching apparatus and the gas inlet system thereof provided by the present invention are described in detail. The principle of the present invention and its implementations are explained using illustrative examples, however, the above mentioned embodiments are only used to help understanding the method of the invention as well as its key concept. It should be pointed out that the persons skilled in the art could make many modifications and variants to the invention without departing from the principle of the present invention, and these modifications and variants are intended to be included within the scope as defined by the accompanying claims of the present invention.

1. A deep-trench silicon etching apparatus comprising:
a reaction chamber; and
a gas source cabinet;
a first gas path, and
a second gas path, the second gas path being independently controlled from the first gas path;
the gas source cabinet being connected to the reaction chamber by the two independently controlled gas paths;
wherein, the first gas path is used to introduce process gas for an etch step from the gas source cabinet into the reaction chamber; and the second gas path is used to introduce process gas for deposition step from the gas source cabinet into the reaction chamber.

2. The deep-trench silicon etching apparatus according to claim 1, further comprising a gas inlet nozzle communicating with the reaction chamber;
each of the first and second independently controlled gas paths include a gas inlet pipeline communicating with the reaction chamber by the gas inlet nozzle; and
first of the two gas inlet pipelines is connected to the process gas source for the etch step and a second of the two gas inlet pipelines is connected to the process gas for the deposition step and both gas inlet pipelines are connected to the reaction chamber via the gas inlet nozzle.

3. The deep-trench silicon etching apparatus according to claim 2, wherein
the gas inlet nozzle includes an inner layer nozzle and an outer layer nozzle; and
a one of the two gas inlet pipelines being connected to the inner layer nozzle and another of the two gas inlet pipelines being connected to the outer layer nozzle.

4. The deep-trench silicon etching apparatus according to claim 3, wherein
the inner layer nozzle is a central through hole within the gas inlet nozzle, one end of the central through hole is connected to the first gas inlet pipeline, and the other end thereof is connected into the reaction chamber; and
the outer layer nozzle includes a gas inlet hole connected to the second gas inlet pipeline, a homogenizing chamber connected to the gas inlet hole, flow division holes connected to the homogenizing chamber, and a gas outlet channel connected to the flow division holes.

5. The deep-trench silicon etching apparatus according to claim 4, wherein
an axis of the gas inlet hole of the outer layer nozzle is perpendicular to an axis of the through hole of the inner layer nozzle;
the homogenizing chamber of the outer layer nozzle is a first hollow ring surrounding the through hole of the inner layer nozzle;
the gas outlet channel of the outer layer nozzle is anther a second hollow ring surrounding the through hole of the inner layer nozzle and connected to the reaction chamber.

6. The deep-trench silicon etching apparatus according to claim 2, wherein
the gas inlet nozzle includes an intermediate nozzle and a flow homogenizing board;
one end of the intermediate nozzle is connected to the first gas inlet pipeline and the other end thereof is connected into the reaction chamber;
the flow homogenizing board with includes a gas inlet hole, a homogenizing chamber and gas outlet holes thereon, wherein, the gas inlet hole is connected to the second gas inlet pipeline.

7. A gas inlet system of a deep-trench silicon etching comprising:
a gas source cabinet;
a reaction chamber; and
a first gas path;
a second gas path, independently controlled from the first gas path, each of the first gas path and second gas path being connected between the gas source cabinet and the reaction chamber;
wherein, the first gas path is used to introduce a process gas for an etch step from the gas source cabinet into the reaction chamber; and the second gas path is used to introduce a process gas for a deposition step from the gas source cabinet into the reaction chamber.

8. The gas inlet system according to claim 7, further comprising:
a gas inlet nozzle; the gas path including a first gas inlet pipeline, the gas path including a second gas inlet pipeline;
the first gas inlet pipeline being connected to the process gas for the etch step and the second gas inlet pipeline being connected to the process gas for the deposition step, and both the first gas inlet pipeline and second gas inlet pipeline are connected to the reaction chamber via the gas inlet nozzle.

9. The gas inlet system according to claim 8, wherein characterized in that the gas inlet nozzle includes an inner layer nozzle and an outer layer nozzle; and
the inner layer nozzle and the outer layer nozzle are connected to the two gas inlet pipelines respectively.

10. The gas inlet system according to claim 9, wherein
the inner layer nozzle is a central through hole within the gas inlet nozzle, one end of the central through hole is connected to the first gas inlet pipeline, and the other end thereof is connected into the reaction chamber;
the outer layer nozzle includes a gas inlet hole connected to the second gas inlet pipeline, a homogenizing chamber connected to the gas inlet hole, flow division holes connected to the homogenizing chamber, and a gas outlet channel connected to the flow division holes.

11. The gas inlet system according to claim 10, wherein
an axis of the gas inlet hole of the outer layer nozzle is perpendicular to an axis of the through hole of the inner layer nozzle;
the homogenizing chamber of the outer layer nozzle is a first hollow ring surrounding the through hole of the inner layer nozzle;
the gas outlet channel of the outer layer nozzle is a second hollow ring surrounding the through hole of the inner layer nozzle and connected to the reaction chamber.

12. The gas inlet system according to claim 8, wherein
the gas inlet nozzle includes an intermediate nozzle and a flow homogenizing board;
one end of the intermediate nozzle is connected to the first gas inlet pipeline and the other end thereof is connected into the reaction chamber;
the flow homogenizing board is provided with a gas inlet hole, a homogenizing chamber and gas outlet holes thereon, and the gas inlet hole is connected to the second gas inlet pipeline.
